(19) United States
(12) Patent Application Publication
(10) Pub. No.: US 2013/0337716 A1
(43) Pub. Date: Dec. 19, 2013

(54) Liquid Crystal Display Device, Manufacturing Method and Equipment for Liquid Crystal Display Panel

(71) Applicants: Jinjie Wang, Shenzhen (CN); Cheng-hung Chen, Shenzhen (CN)

(72) Inventors: Jinjie Wang, Shenzhen (CN); Cheng-hung Chen, Shenzhen (CN)

(73) Assignee: SHENZHEN CHINA STAR OPTOELECTRONICS TECHNOLOGY CO. LTD., Shenzhen (CN)

(21) Appl. No.: 13/575,304

(22) PCT Filed: Jun. 25, 2012
(86) PCT No.: PCT/CN12/77413

§ 371 Date: Jul. 26, 2012

(30) Foreign Application Priority Data
Jun. 13, 2012 (CN) 201210194314.0

(51) Int. Cl. G02F 1/1333; G02F 1/13

(52) U.S. Cl. CPC G02F 1/1333; G02F 1/1303
USPC 445/3; 445/63

(57) ABSTRACT

The present invention provides a manufacturing method for liquid crystal display panel, which includes: applying a voltage to form an electrical field between upper and lower substrates of liquid crystal display panel; forming layout and pretilt angle of liquid crystal molecules under the effect of electrical field; releasing the voltage between upper and lower substrates after forming pretilt angle of liquid crystal molecules. The present invention also provides a manufacturing method for liquid crystal display device and a manufacturing equipment for liquid crystal display panel. As such, reduces the dark pattern or fragmented bright spots in liquid crystal display panel and improve the displaying result of the liquid crystal display panel.

### BACKGROUND OF THE INVENTION

1. Field of the Invention

The present invention relates to the field of liquid crystal displaying techniques, and in particular to a liquid crystal display device, manufacturing method and equipment for liquid crystal display panel.

2. The Related Arts

As liquid crystal displaying techniques undergo fast development recently, the wide view angle technique in liquid crystal displaying also moves forwards to a new level. Wide view angle technique is used as a direct criterion to judge the displaying quality of display panel. The wide view angle technique is not only related to view angle of display panel, but also related to the response time, luminance and other performance parameters of display panel. For better display result, the demand on wide view angle technique is also getting higher.

The main wide view angle techniques include Twisted Nematic+Film (TN+Film), Vertical Alignment (VA), and In Plane Switch (IPS). VA-based technique is more popular in current display devices and is the mainstream technique. VA can be further divided into multi-domain vertical alignment (MVA); patterned vertical alignment (PVA), polymer-stabilized vertical alignment (PSVA), and so on, corresponding to MVA panel, PVA panel and PSVA panel respectively. Each type of panel has own advantages and disadvantages. In comparison to MVA panel and PVA panel, the advantages of PSVA panel include: good black state, short response time, high transmittance, low cost, not requiring bumps or Indium Tin Oxides (ITO) on upper and lower substrates. Therefore, PSVA wide view angle technique enables display panel to perform better with better displaying result.

PSVA technique is to dope specific monomer in liquid crystal. Under the radiation of specific UV ray, liquid crystal molecules form a pretilt angle and line up accordingly. As shown in FIG. 1, during PSVA process, the key step is step S13, i.e., performing first UV radiation. Specifically, a voltage is applied to upper substrate 1 and lower substrate 2 on both sides of liquid crystal molecules 12 and perform a first UV radiation to make monomer 13 of liquid crystal molecules 12 condense on surface of polymide (PI) 11 so that liquid crystal molecules 12 have pretilt angle. In the instant, step S11 is the state of liquid crystal molecules 12 prior to applying voltage, liquid crystal molecules 12 show no pretilt angle and monomer 12 is doped in liquid crystal molecules 12. Step S12 is applying a voltage to upper substrate 1 and lower substrate 2 on both sides of liquid crystal molecules 12 to make liquid crystal molecules 12 tilt to show pretilt angle. Step S13 is to perform UV radiation. Under the effect of UV ray, monomer 13 moves towards PI 11 on two sides and condenses on surface of PI 11. Step S14 is to finish UV radiation and turn off power. Under the effect of monomer 13, liquid crystal molecules 12 cure to form pretilt angle.

After the first UV radiation, the steps shown in FIG. 2 are usually taken to turn off the equipment. First step is to turn off UV light source (step S21), and then turn off power. (Step S22). After power off, the probe used to apply voltage to upper and lower substrates is lowered, as shown in step S23. During this process, prior to lowering the probe, the power is turned off directly without discharging the capacitance of the cell panel.

Referring to FIG. 3, FIG. 3 shows a schematic view of liquid crystal molecule deflection during roller transport of cell panel after finishing first UV radiation. Step S31 is the initial state of liquid crystal molecules 12′ after finishing first UV radiation, i.e., maintaining a pretilt angle. Step S32 shows performing roller transport on cell panel. Step S33 us to release cell panel from the roller. Step S34 is to perform the second UV radiation. Because liquid crystal molecules 12′ still maintains a pretilt angle after the first UV radiation finishes, the pressure in step S32 performing roller transport on cell panel makes liquid crystal molecules 12′ display an even larger angle deflection, as liquid crystal molecules 12′ shown in the dash line part in FIG. 3. During shutting down equipment process in FIG. 2, capacitance discharge is not performed on cell panel, and charge exists in the panel, which leads to the difficulty of restoring liquid crystal molecules with large angle deflection to initial state. After the second UV radiation, the larger deflection angle is preserved in liquid crystal molecules to make panel display dark pattern as well as fragmented bright spots when liquid crystal molecules 12′ tilt and the radiation continues to affect the displaying result.

### SUMMARY OF THE INVENTION

The technical issue to be addressed by the present invention is to provide a liquid crystal display device, manufacturing method and equipment for liquid crystal display panel to reduce the dark pattern and fragmented bright spots in liquid crystal display panel and improve displaying result of liquid crystal display panel.

The present invention provides a manufacturing method for liquid crystal display panel, which comprises: applying a voltage to form an electrical field between upper and lower substrates of liquid crystal display panel; forming layout and pretilt angle of liquid crystal molecules under the effect of electrical field; releasing the voltage between upper and lower substrates after forming pretilt angle of liquid crystal molecules; and the step before applying a voltage to form an electrical field between upper and lower substrates of liquid crystal display panel comprises: forming polyimide (PI) on surfaces of upper and lower substrates of liquid crystal display panel respectively and doping monomers in liquid crystal molecules between upper and lower substrates; the step of releasing the voltage between upper and lower substrates after forming pretilt angle of liquid crystal molecules comprises: slowly reducing voltage between upper and lower substrates to zero after forming pretilt angle of liquid crystal molecules; and turning off equipment power for forming pretilt angle of liquid crystal molecules after voltage gradually reduced to zero.

According to a preferred embodiment of the present invention, the steps after releasing the voltage between upper and lower substrates after forming pretilt angle of liquid crystal molecules comprise: using roller to transport liquid crystal panel placed flatly on the roller to the position of curing liquid crystal molecule layout; and performing UV radiation or heating on liquid crystal molecules between upper and lower substrates of liquid crystal display panel to fix the layout of liquid crystal molecules.

According to a preferred embodiment of the present invention, the step of forming layout and pretilt angle of liquid crystal molecules under the effect of electrical field is specifically as: performing UV radiation or heating on liquid crystal molecules between upper and lower substrates of liquid crystal display panel to fix the layout of liquid crystal molecules.

The present invention provides a manufacturing method for liquid crystal display device, which comprises a manufacturing method for liquid crystal display panel, which comprises: applying a voltage to form an electrical field between upper and lower substrates of liquid crystal display panel; forming layout and pretilt angle of liquid crystal molecules under the effect of electrical field; releasing the voltage between upper and lower substrates after forming pretilt angle of liquid crystal molecules.

According to a preferred embodiment of the present invention, the step of releasing the voltage between upper and lower substrates after forming pretilt angle of liquid crystal molecules comprises: slowly reducing voltage between upper and lower substrates to zero after forming pretilt angle of liquid crystal molecules; and turning off equipment power for forming pretilt angle of liquid crystal molecules after voltage gradually reduced to zero.

According to a preferred embodiment of the present invention, the steps after releasing the voltage between upper and lower substrates after forming pretilt angle of liquid crystal molecules comprise: using roller to transport liquid crystal panel placed flatly on the roller to the position of curing liquid crystal molecule layout; and performing UV radiation or heating on liquid crystal molecules between upper and lower substrates of liquid crystal display panel to fix the layout of liquid crystal molecules.

According to a preferred embodiment of the present invention, the step of forming layout and pretilt angle of liquid crystal molecules under the effect of electrical field is specifically as: performing UV radiation or heating on liquid crystal molecules between upper and lower substrates of liquid crystal display panel to fix the layout of liquid crystal molecules.

The present invention provides a manufacturing equipment for liquid crystal display panel, which comprises: a voltage-applying mechanism, for applying a voltage to form an electrical field between upper and lower substrates of liquid crystal display panel; a first curing mechanism, for making liquid crystal molecules between the upper and lower substrates to form pretilt angle under the effect of the electrical field; and a discharging mechanism, for releasing the voltage between upper and lower substrates after forming pretilt angle of liquid crystal molecules.

According to a preferred embodiment of the present invention, the discharging mechanism comprises: a voltage-lowering circuit, for gradually lowering voltage between the upper and lower substrates after forming pretilt angle of liquid crystal molecules; a control circuit, for detecting voltage difference between upper and lower substrates and stopping voltage-lowering circuit operation when voltage difference reduced to zero; and a shut-down circuit, for turning power of voltage-applying mechanism and first curing mechanism off when voltage difference reduced to zero.

According to a preferred embodiment of the present invention, a transport mechanism is for using roller to transport liquid crystal panel placed flatly on the roller to the position of curing liquid crystal molecule layout after shut-down circuit turns off the power.

According to a preferred embodiment of the present invention, a second curing mechanism is for performing UV radiation or heating on liquid crystal molecules between upper and lower substrates of liquid crystal display panel transported from the transport mechanism to fix the layout of liquid crystal molecules.

The efficacy of the present invention is that to be distinguished from the state of the art. The present invention applies a voltage to from electrical field between the upper and lower substrates of liquid crystal display panel to make liquid crystal molecules between the upper and lower substrates forming pretilt angle under the effect of electrical field, and, through releasing the voltage between upper and lower substrates after forming pretilt angle of liquid crystal molecules, reduces the dark pattern or fragmented bright spots in liquid crystal display panel and improve the displaying result of the liquid crystal display panel.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing a known technique performing first UV radiation on liquid crystal molecules to form pretilt angle;

FIG. 2 is a flowchart of turning off equipment after liquid crystal molecules forming pretilt angle in a known technique;

FIG. 3 is a schematic view showing a known technique performing second UV radiation on liquid crystal molecules;

FIG. 4 is a flowchart of an embodiment of the manufacturing method for liquid crystal display panel according to the present invention;

FIG. 5 is a flowchart of an embodiment of releasing the voltage between upper and lower substrates after forming pretilt angle of liquid crystal molecules in FIG. 4;

FIG. 6 is a schematic view showing waveform of gradually reducing voltages of common electrode and scan line to zero in FIG. 5;

FIG. 7 is a flowchart of an embodiment of after releasing the voltage between upper and lower substrates after forming pretilt angle of liquid crystal molecules in FIG. 4;

FIG. 8 is a schematic view of liquid crystal molecule deflection before and after roller transport in liquid crystal display panel of FIG. 7; and

FIG. 9 is a schematic view showing the structure of an embodiment of the manufacturing equipment for liquid crystal display panel according to the present invention.

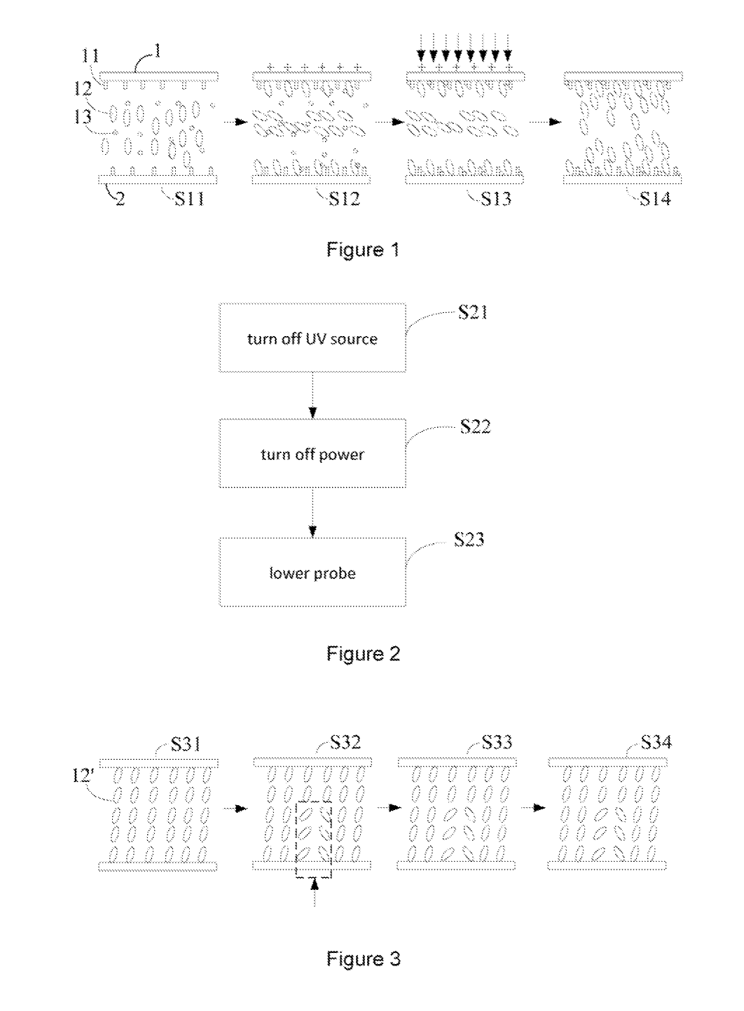

### DETAILED DESCRIPTION OF THE PREFERRED EMBODIMENTS

The manufacturing method for liquid crystal display panel of the present invention can reduce the dark pattern or fragmented bright spots in liquid crystal display panel and improve the displaying result of the liquid crystal display panel.

The following description refers to drawing and embodiments of the present invention.

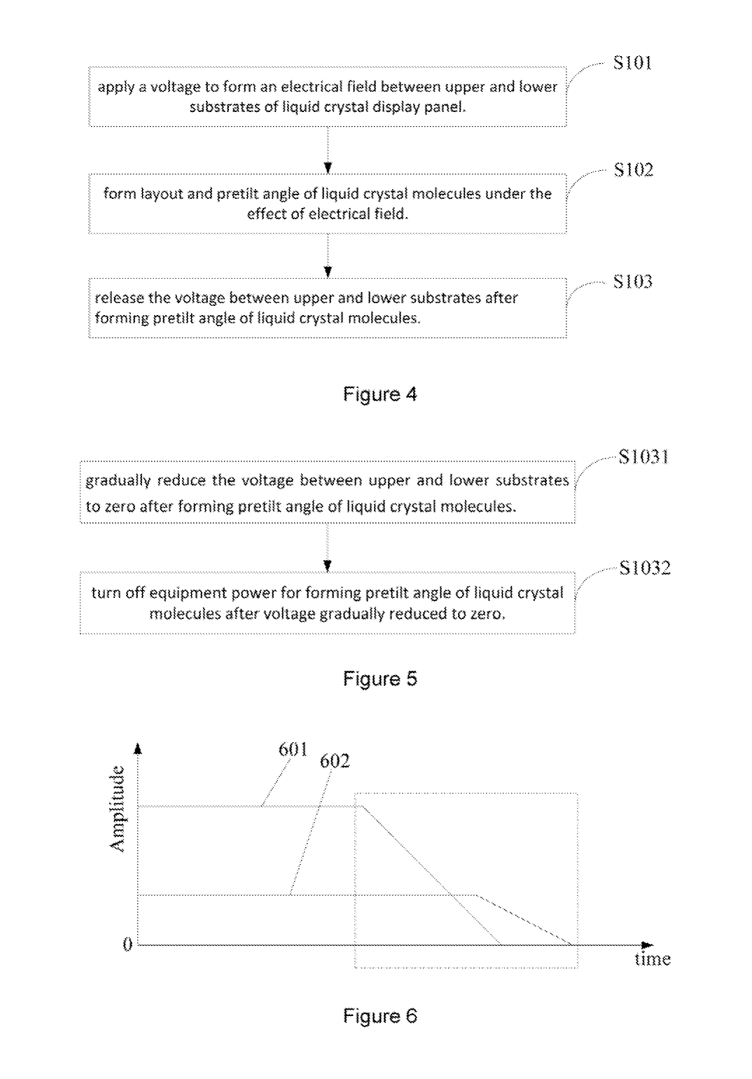

Referring to FIG. 4, FIG. 4 is a flowchart of an embodiment of the manufacturing method for liquid crystal display panel according to the present invention, which comprises:

Step S101: applying a voltage to form an electrical field between upper and lower substrates of liquid crystal display panel.

During the first UV radiation process of PSVA liquid crystal display panel manufacturing process, the electrode structure of the upper and lower substrates on two sides of liquid crystal layer is connected to voltage source to form an electrical field between the upper and lower substrates. Before applying a voltage to form an electrical field between upper and lower substrates of liquid crystal display panel, polyimide (PI) is formed on surfaces of upper and lower substrates of liquid crystal display panel respectively and monomers are doped in liquid crystal molecules between upper and lower substrates to prepare conditions for liquid crystal molecules to form pretilt angle during the first UV radiation.

Step S102: forming layout and pretilt angle of liquid crystal molecules under the effect of electrical field.

The layout and orientation of liquid crystal molecules is a key to the manufacturing of liquid crystal display panel. The pattern and quality of layout will form different types of display panel and affect other parameters of display panel. The reaction of liquid crystal molecules and polyimide (PI) before applying voltage will determine the layout of liquid crystal molecules and layout stability. After applying a voltage to form an electrical field between upper and lower substrates of liquid crystal display panel, the liquid crystal molecules are no longer restricted by the PI; instead, liquid crystal molecules deflect and shift under the influence of electrical field to form a specific layout and pretilt angle. After applying voltage, UV radiation is performed on liquid crystal molecules between upper and lower substrates of liquid crystal display panel. The monomers in liquid crystal molecules, under UV radiation, condense on surface of PI. During condensation, the layout of liquid crystal molecules is fixed so that liquid crystal molecules show specific layout and pretilt angle.

Obviously, heating can also make monomers in liquid crystal molecules, under UV radiation condense on the surface of PI, which also results in fixing liquid crystal molecules to show specific layout and pretilt angle.

Step S103: releasing the voltage between upper and lower substrates after forming pretilt angle of liquid crystal molecules.

Step 1031: gradually reducing the voltage between upper and lower substrates to zero after forming pretilt angle of liquid crystal molecules.

Through releasing the voltage between upper and lower substrates, the voltage on common electrode and scan line performing curing on liquid crystal molecules is gradually reduced to zero. As shown in FIG. 6, curve 601 indicates the process of common electrode reducing from 19V to 0V, and curve 602 indicates the process of scan line reducing from 5V to 0V, as the dash line shows.

Step S1032: turning off equipment power for forming pretilt angle of liquid crystal molecules after voltage gradually reduced to zero.

After the voltage between the upper and lower substrates is released, turning off equipment power for forming pretilt angle of liquid crystal molecules and then the probe is lowered.

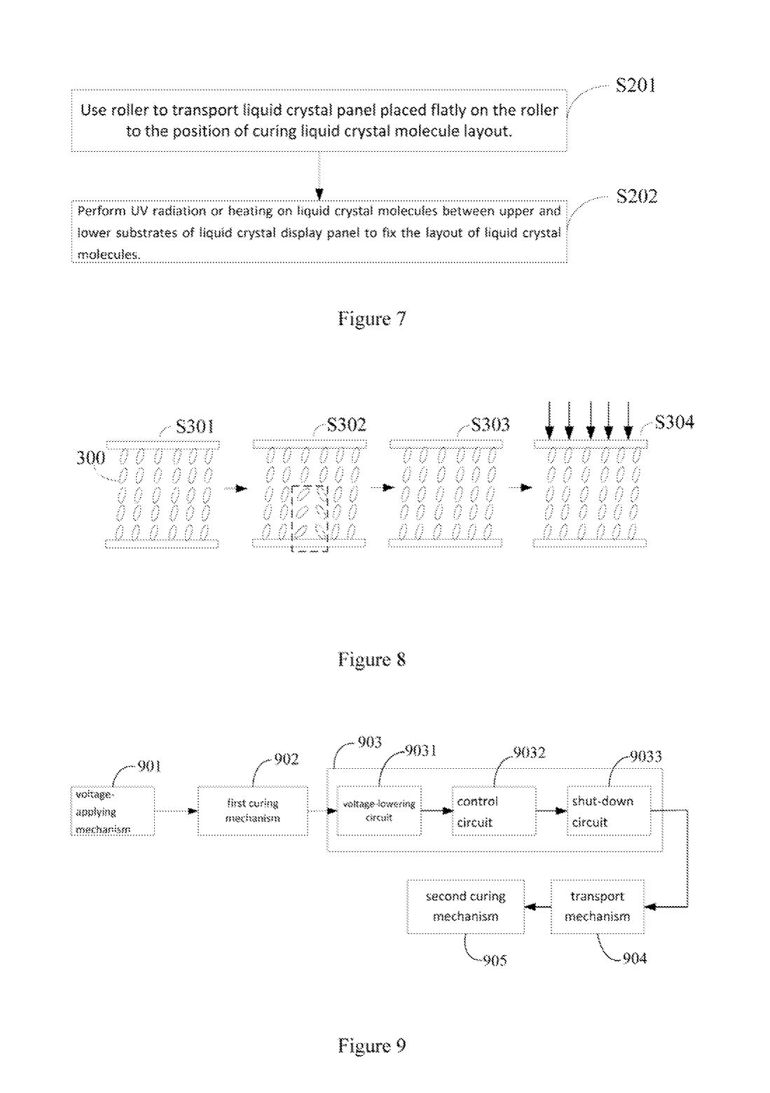

The above steps are the process of the first UV radiation (UV1) of the embodiment of the manufacturing method for liquid crystal display panel of the present invention. The process comprises applying voltage between the upper and lower substrates, using UV radiation or heating to polymerize the monomers doped in the liquid crystal molecules to make liquid crystal molecules to form fixed layout and pretilt angle, and then releasing voltage between the upper and lower substrates. Referring to FIGS. 7-8, after releasing voltage between the upper and lower substrates, the second UV radiation process (UV2) comprises specifically:

Step S201: using roller to transport liquid crystal panel placed flatly on the roller to the position of curing liquid crystal molecule layout.

As shown in FIG. 8, step S301 is the deflection state of liquid crystal molecules 300 after finishing the first UV radiation. In Step S302, liquid crystal molecules 300 may show larger deflection angle (as shown in dash line part of FIG. 8) after pressure during roller transportation. When entering step S303, releasing liquid crystal display panel restores liquid crystal molecules to initial deflection state to enter the next processing position.

Step S202: performing UV radiation or heating on liquid crystal molecules between upper and lower substrates of liquid crystal display panel to fix the layout of liquid crystal molecules.

After restoring liquid crystal molecules to initial deflection state for the second UV radiation (step S304 of FIG. 8), the first step is to check the alignment (i.e., layout and pretilt angle) of the liquid crystal molecules, and then perform UV radiation or heating without applying voltage to upper and lower substrates to rid of the remaining monomers after first UV radiation to further fix the layout of liquid crystal molecules.

In the manufacturing method for liquid crystal display panel of the present invention, in step S201, liquid crystal molecules may show larger deflection angle after pressure during roller transportation. However, before step S201, the voltage between upper and lower is released so that the liquid crystal molecules having larger deflection angle caused by pressure during roller transportation can restore normal state easily without the effect of electrical field, i.e., to the initial state after finishing the first UV radiation so that the liquid crystal molecules do not have larger deflection angle in second UV radiation to as to reduce the dark pattern or fragmented bright spots in liquid crystal display panel and improve displaying result.

The present invention further provides a manufacturing equipment for liquid crystal display panel, using the aforementioned manufacturing method.

Referring to FIG. 9, the manufacturing equipment comprises: a voltage-applying mechanism 901, for applying a voltage to form an electrical field between upper and lower substrates of liquid crystal display panel; a first curing mechanism 902, for making liquid crystal molecules between the upper and lower substrates to form pretilt angle under the effect of the electrical field; and a discharging mechanism 903, for releasing the voltage between upper and lower substrates after forming pretilt angle of liquid crystal molecules.

In the instant embodiment, voltage-applying mechanism can be a power equipment, connected to electrode structure of the upper and lower substrates to apply voltage to form electrical field. After forming electrical field, the liquid crystal molecules between the upper and lower substrates can deflect and shift under the effect of electrical field. First curing mechanism 902 can be a UV source. Through UV radiation by UV source on liquid crystal molecules, monomers in liquid crystal molecules condense on PI so as to fix the layout of liquid crystal molecules. First curing mechanism can also be a heat source. Heating liquid crystal molecules can also realize the objective of fixing the layout and pretilt of liquid crystal molecules.

In the instant embodiment, discharging mechanism 903 comprises: a voltage-lowering circuit 9031, for gradually lowering voltage between the upper and lower substrates after forming pretilt angle of liquid crystal molecules; a control circuit 9032, for detecting voltage difference between upper and lower substrates and stopping voltage-lowering circuit 9031 operation when voltage difference reduced to zero; and a shut-down circuit 9033, for turning power of voltage-applying mechanism 901 and first curing mechanism 902 off when voltage difference reduced to zero. After liquid crystal molecules forming fixed layout and pretilt angle and before turning off equipment, voltage-lowering circuit 9031 first releases voltage between the upper and lower substrates. When the voltage between the upper and lower substrates is released to zero, shut-down circuit 9033 turns the power of voltage-applying mechanism 901 and first curing mechanism 902 off.

In the instant embodiment, the manufacturing equipment for liquid crystal display panel of the present invention further comprises a transport mechanism 904, for using roller to transport liquid crystal panel placed flatly on the roller to the position of curing liquid crystal molecule layout after shut-down circuit 9033 turns off the power; and a second curing mechanism 905, for performing UV radiation or heating on liquid crystal molecules between upper and lower substrates of liquid crystal display panel transported from transport mechanism 904 to fix the layout of liquid crystal molecules.

In the present embodiment, after liquid crystal molecules of liquid crystal display panel forming fixed layout and pretilt, voltage-lowering circuit 9031 first releases the voltage between upper and lower substrate, and then shut-down circuit 9033 turns off power of related equipment so that the liquid crystal molecules with larger deflection angle after transported by transport mechanism 904 can restore to normal state faster without the effect of electrical field (i.e., having fixed layout and pretilt angle) so that the liquid crystal molecules of liquid crystal display panel, when entering second curing mechanism 905, maintain the state after the first curing mechanism 902 without larger deflection angle. As such, the present invention can reduce the dark patterns and fragmented bright spots in the liquid crystal display panel and improve the displaying result.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A manufacturing method for liquid crystal display panel, which comprises:
applying a voltage to form an electrical field between upper and lower substrates of liquid crystal display panel;
forming layout and pretilt angle of liquid crystal molecules under the effect of electrical field;
releasing the voltage between upper and lower substrates after forming pretilt angle of liquid crystal molecules;
step before applying a voltage to form an electrical field between upper and lower substrates of liquid crystal display panel comprises:
forming polyimide (PI) on surfaces of upper and lower substrates of liquid crystal display panel respectively and doping monomers in liquid crystal molecules between upper and lower substrates;
step of releasing the voltage between upper and lower substrates after forming pretilt angle of liquid crystal molecules comprises:
gradually reducing the voltage to zero over a period of time between upper and lower substrates after forming pretilt angle of liquid crystal molecules; and
turning off equipment power for forming pretilt angle of liquid crystal molecules after voltage gradually reduced to zero.

2. The method as claimed in claim 1, characterized in that:
steps after releasing the voltage between upper and lower substrates after forming pretilt angle of liquid crystal molecules comprise:
using roller to transport liquid crystal panel placed flatly on the roller to the position of curing liquid crystal molecule layout; and
performing UV radiation or heating on liquid crystal molecules between upper and lower substrates of liquid crystal display panel to fix the layout of liquid crystal molecules.

3. The method as claimed in claim 2, characterized in that:
step of forming layout and pretilt angle of liquid crystal molecules under the effect of electrical field is specifically as:
performing UV radiation or heating on liquid crystal molecules between upper and lower substrates of liquid crystal display panel to fix the layout of liquid crystal molecules.

4. A manufacturing method for liquid crystal display device, which comprises a manufacturing method for liquid crystal display panel, which comprises:
applying a voltage to form an electrical field between upper and lower substrates of liquid crystal display panel;
forming layout and pretilt angle of liquid crystal molecules under the effect of electrical field; and
releasing the voltage between upper and lower substrates after forming pretilt angle of liquid crystal molecules;
characterized in that steps of releasing the voltage between upper and lower substrates after forming pretilt angle of liquid crystal molecules comprise
gradually reducing the voltage to zero over a period of time between upper and lower substrates after forming pretilt angle of liquid crystal molecules; and
turning off equipment power for forming pretilt angle of liquid crystal molecules after voltage gradually reduced to zero.

5. (canceled)

6. The method as claimed in claim 4, characterized in that:
steps after releasing the voltage between upper and lower substrates after forming pretilt angle of liquid crystal molecules comprise:
using roller to transport liquid crystal panel placed flatly on the roller to the position of curing liquid crystal molecule layout; and
performing UV radiation or heating on liquid crystal molecules between upper and lower substrates of liquid crystal display panel to fix the layout of liquid crystal molecules.

7. The method as claimed in claim 6, characterized in that:
step of forming layout and pretilt angle of liquid crystal molecules under the effect of electrical field is specifically as:
performing UV radiation or heating on liquid crystal molecules between upper and lower substrates of liquid crystal display panel to fix the layout of liquid crystal molecules.

8. A manufacturing equipment for liquid crystal display panel, which comprises:
a voltage-applying mechanism, for applying a voltage to form an electrical field between upper and lower substrates of liquid crystal display panel;
a first curing mechanism, for making liquid crystal molecules between the upper and lower substrates to form pretilt angle under the effect of the electrical field; and
a discharging mechanism, for releasing the voltage between upper and lower substrates after forming pretilt angle of liquid crystal molecules, wherein the discharging mechanism further comprising:
a voltage-lowering circuit, for gradually lowering voltage to zero over a period of time between the upper and lower substrates after forming pretilt angle of liquid crystal molecules;
a control circuit, for detecting voltage difference between upper and lower substrates and stopping voltage-lowering circuit operation when voltage difference reduced to zero; and
a shut-down circuit, for turning power of voltage-applying mechanism and first curing mechanism off when voltage difference reduced to zero.

9. (canceled)

10. The equipment as claimed in claim 8, characterized in that the equipment comprises:
a transport mechanism, for using roller to transport liquid crystal panel placed flatly on the roller to the position of curing liquid crystal molecule layout after shut-down circuit turns off the power.

11. The equipment as claimed in claim 10, characterized in that the equipment comprises:
a second curing mechanism, for performing UV radiation or heating on liquid crystal molecules between upper and lower substrates of liquid crystal display panel transported from the transport mechanism to fix the layout of liquid crystal molecules.
